(19) United States
(12) Patent Application Publication
(10) Pub. No.: US 2006/0132407 A1
(43) Pub. Date: Jun. 22, 2006

(54) Liquid crystal display apparatus

(75) Inventor: Jiro Isoo, Tottori-shi (JP)

Correspondence Address: MCDERMOTT WILL & EMERY LLP, 600 13TH STREET, N.W., WASHINGTON, DC, 20005-3096, US

(73) Assignee: SANYO EPSON IMAGING DEVICES CORP.

(21) Appl. No.: 11/289,721

(22) Filed: Nov. 30, 2005

(30) Foreign Application Priority Data
Dec. 22, 2004 (JP) 2004-370563(P)

(51) Int. Cl. G09G 3/36

(52) U.S. Cl. 345/89

(57) ABSTRACT

There are provided a liquid crystal display panel 2, a resin frame member 3 on which the liquid crystal display panel 2 is mounted and that is formed in the shape of a picture frame, and a front-face frame 6 that is formed in the shape of a box having an open portion 6a, that covers an edge portion of the liquid crystal display panel 2 and the resin frame member 3, and that, at the side faces hereof, engages with the resin frame member 3. On the resin frame member 3, a projection 33 in the shape of a picture frame is formed to project therefrom so as to surround an outer edge portion of the liquid crystal display panel 2 mounted above. In a tip portion of the projection 33, ribs 34 having a predetermined height are formed at a predetermined interval in the length direction of the picture frame. The ribs 34 support the front-face frame 6.

This application is based on Japanese Patent Application No. 2004-370563 filed on Dec. 22, 2004, the contents of which are hereby incorporated by reference.

### BACKGROUND OF THE INVENTION

1. Field of the Invention

The present invention relates to a liquid crystal display apparatus, and more particularly to the structure of a frame member provided between a backlight unit and a liquid crystal display panel.

2. Description of Related Art

Conventionally, this type of apparatus is disclosed, for example, in Japanese Patent Application Laid-open No. H11-160681 (hereinafter referred to as Patent Publication 1). As shown in a partial sectional view in FIG. 9, the liquid crystal display apparatus 100 disclosed in Patent Publication 1 is provided with a resin frame member 103 that supports a liquid crystal display panel 101. This frame member 103 is located between the liquid crystal panel 101 and a backlight unit 102, and has a base portion 103a that forms a predetermined gap and a rib 103b that protrudes toward the front face of the liquid crystal display apparatus 100 to support a front-face frame 104 and is substantially rectangular-shaped as seen in a plan view.

Thus, in the liquid crystal display apparatus 100 disclosed in Patent Publication 1, the provision of the frame member 103 helps to form a predetermined gap d between the front-face frame 104 and the liquid crystal panel 101. Because the front-face frame 104 is supported on the rib 103b in this way, the front-face frame 104 is prevented from making contact with the liquid crystal panel 101.

### SUMMARY OF THE INVENTION

In this way, the front-face frame 104 is supported on the rib 103b so as to prevent contact between the front-face frame 104 and the liquid crystal panel 101. However, since this frame member 103 is formed of resin, and the rib 103b, which is substantially rectangular-shaped as seen in a plan view, is provided continuously, the resin may deform or warp (described as “resin going out of shape”) in particular in the longer-side portions thereof, resulting in an uneven clearance between the front-face frame 104 and the liquid crystal panel 101. This may cause the front-face frame 104 to make partial contact with, and thus interfere with, the liquid crystal panel 101, leading to degraded display.

In view of the above problem, the inventor of the present invention has studied various liquid crystal display apparatuses in which a front-face frame can be more securely supported on a resin frame member, and has found that it is possible to prevent the resin frame member from going out of shape by supporting the front-face frame on ribs that are formed with a predetermined height and at a predetermined interval on a projection having a predetermined height so that the front-face frame supporting portion formed by the ribs and projection has such bumps and dips as to resist deformation. This finding has led the inventor to make the present invention.

Specifically, an object of the present invention is to provide a liquid crystal display apparatus in which degraded display resulting from contact between a front-face frame and a liquid crystal display panel is prevented.

To achieve the above object, according to one aspect of the present application, a liquid crystal display apparatus is provided with: a liquid crystal display panel; a resin frame member on which the liquid crystal display panel is mounted and that is formed in the shape of a picture frame; and a front-face frame that is formed in the shape of a box having an open portion, that covers an edge portion of the liquid crystal display panel and the frame member, and that, at the side faces thereof, engages with the frame member. Here, the frame member has formed thereon: a projection formed to project therefrom in the shape of a picture frame so as to surround an outer edge portion of the liquid crystal display panel; and ribs formed with a predetermined height in a tip portion of the projection and arranged at a predetermined interval in the length direction of the picture frame. These ribs support the front-face frame.

In this structure, the ribs that support the front-face frame of the resin frame member are formed with a predetermined height and at a predetermined interval on the projection. Thus, the front-face frame supporting portion formed by the ribs and projection has such bumps and dips as to make deformation or warping (described as “resin going out of shape”) after resin molding less likely. This prevents the clearance between the front-face frame and the liquid crystal display panel from becoming uneven as a result of the resin going out of shape.

Moreover, according to another aspect of the present invention, in the liquid crystal display apparatus described above, the ribs are formed at least in four comers of the projection in the shape of the picture frame.

In this structure, the ribs are formed in the four comers of the projection in the shape of a picture frame so as to support the front-face frame in the comer portions thereof where it is comparatively strong and flat. This helps make the clearance between the front-face frame and the liquid crystal display panel more even.

Moreover, according to another aspect of the present invention, in the liquid crystal display apparatus described above, there is provided a back case on which a backlight unit located below the liquid crystal display panel is mounted. The back case, at the side faces thereof, engages with the frame member. The frame member is formed by joining together a pair of shorter-side frame segments and a pair of longer-side frame segments. One of the pair of shorter-side frame segments has a plurality of holes formed therein so as to extend in the length direction and penetrate in the height direction.

In this structure, a back case is provided on which a backlight unit located below the liquid crystal display panel is mounted, and the back case, at the side faces thereof, engages with the frame member. Of all the sides of the frame member, one shorter-side frame segment has a plurality of holes formed therein so as to extend in the length direction and penetrate in the height direction. The shorter-side frame segment thus having holes formed therein is mechanically less strong and easier to deform. This facilitates attachment and detachment of the frame member to and from the liquid crystal display apparatus.

Moreover, according to another aspect of the present invention, in the liquid crystal display apparatus described above, the projection in the shape of the picture frame is so formed as to be lower in the portion thereof where a wiring circuit board of the liquid crystal display panel mounted thereon is located than elsewhere.

In this structure, the projection formed in the portion of the frame member where a wiring circuit board of the liquid crystal display panel is located is made lower than elsewhere. This makes it easier to lay the wiring circuit board.

### BRIEF DESCRIPTION OF THE DRAWINGS

FIG. 1 is an exploded perspective view showing a liquid crystal display apparatus embodying the present invention;

FIG. 2 is a perspective view showing the frame member provided in the liquid crystal display apparatus;

FIG. 3 is an enlarged view showing, on an enlarged scale, principal portions of the frame member;

FIG. 4 is a plan view showing a liquid crystal display apparatus embodying the present invention;

FIG. 5 is a sectional view along line D-D shown in FIG. 4;

FIG. 6 is a sectional view along line E-E shown in FIG. 4;

FIG. 7 is a sectional view along line F-F shown in FIG. 4;

FIG. 8 is a sectional view along line G-G shown in FIG. 4; and

FIG. 9 is a sectional view showing a portion of a prior-art liquid crystal display apparatus.

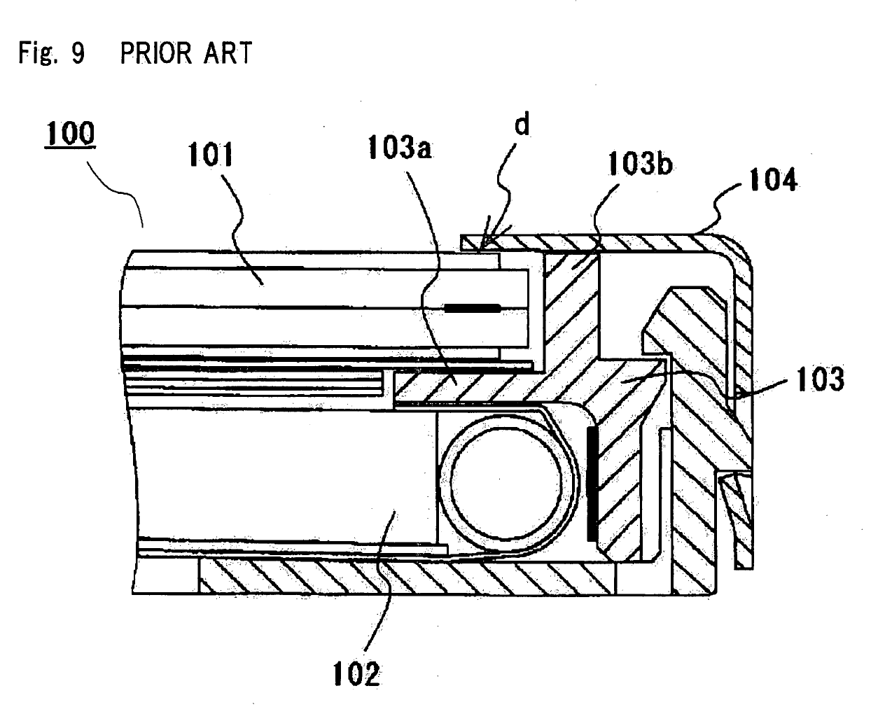

### DETAILED DESCRIPTION OF PREFERRED EMBODIMENTS

Hereinafter, with reference to the accompanying drawings, the best mode of carrying out the present invention will be described. It should be understood that the embodiments specifically described below are merely examples of liquid crystal display apparatuses to which the technical idea of the present invention is practically applied, and are not meant to limit the application of the present invention in any way, but should be taken as encompassing various embodiments practiced within the scope of the appended claims.

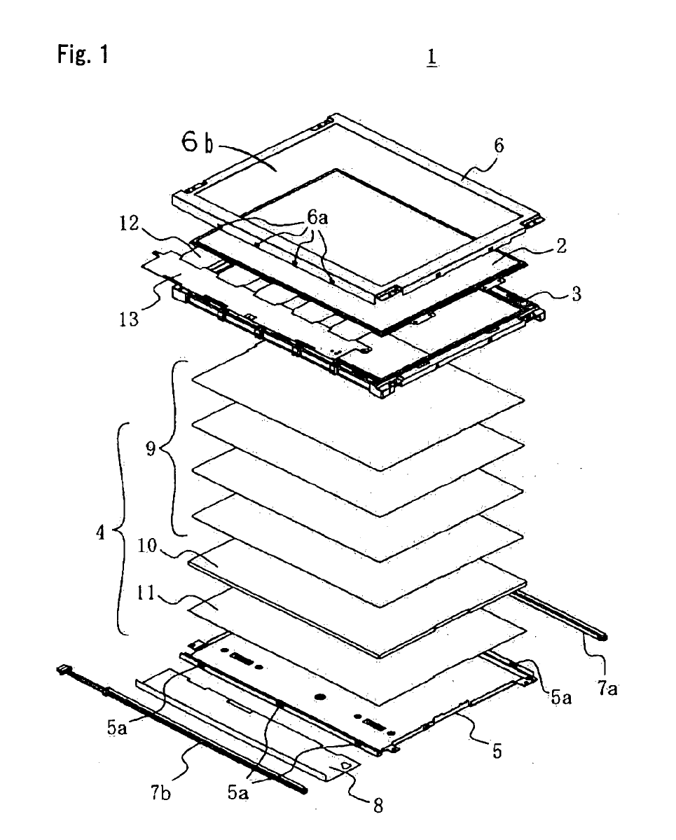

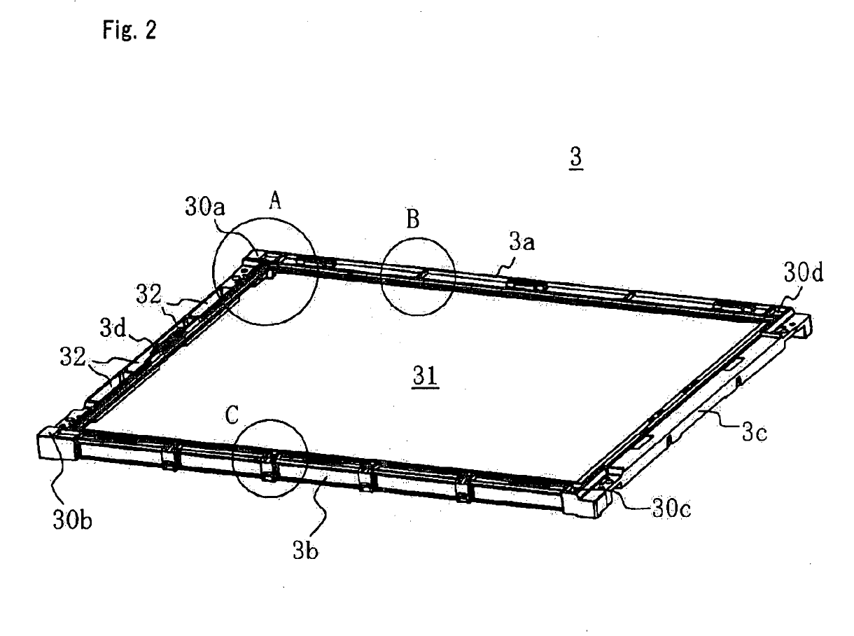

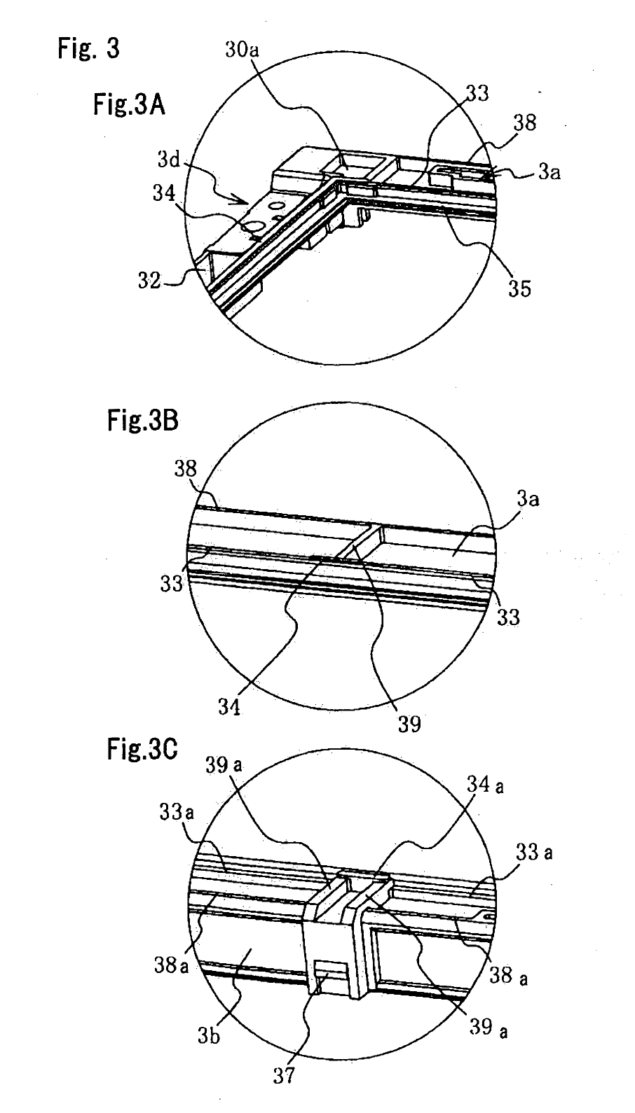

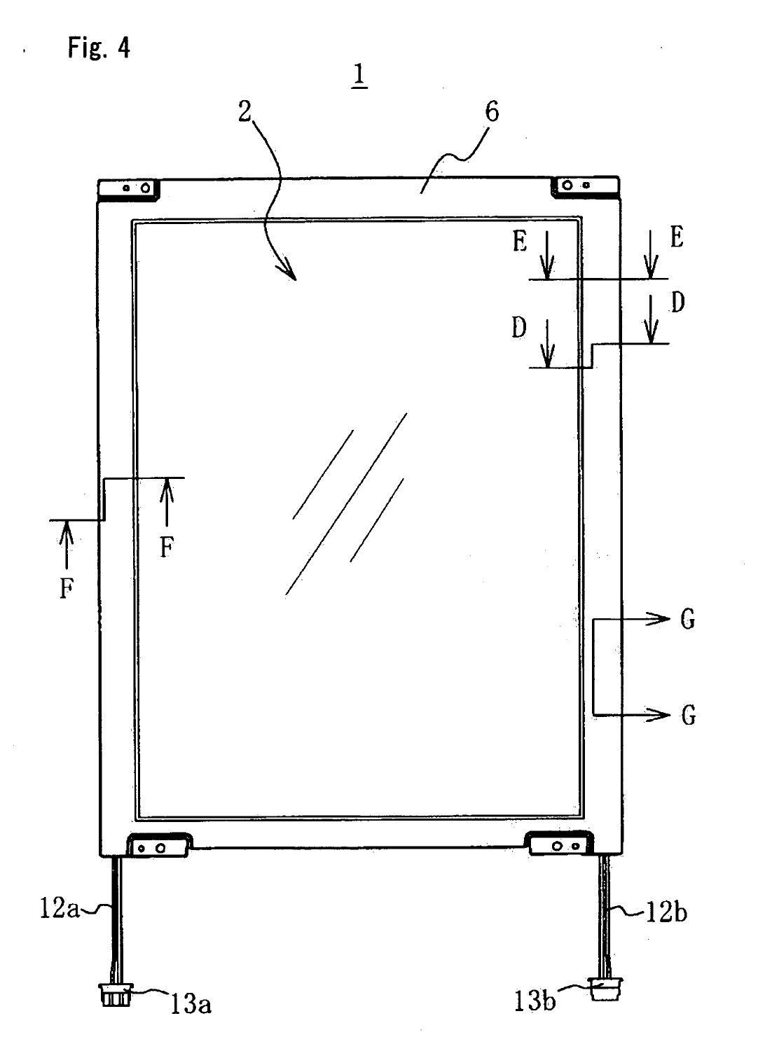

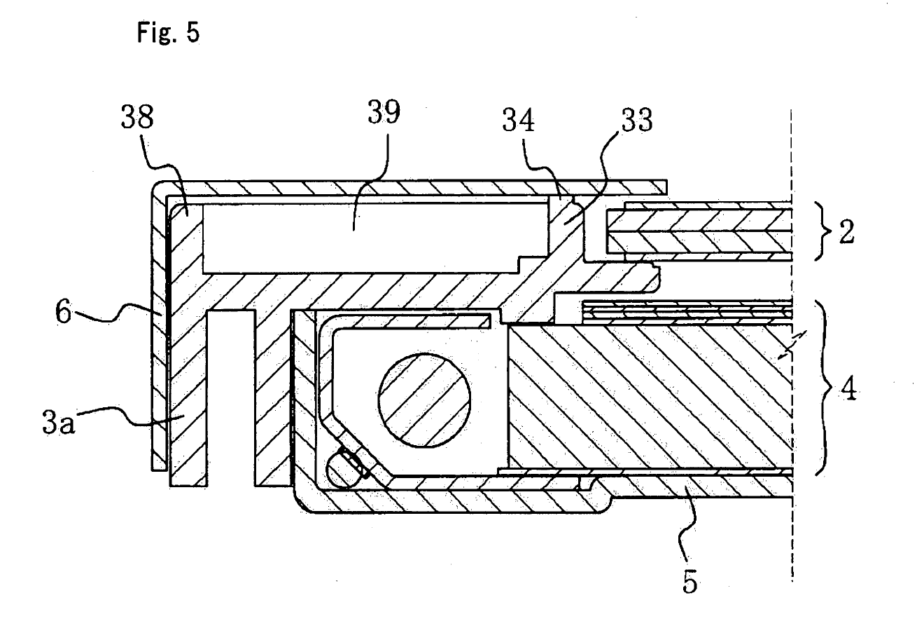

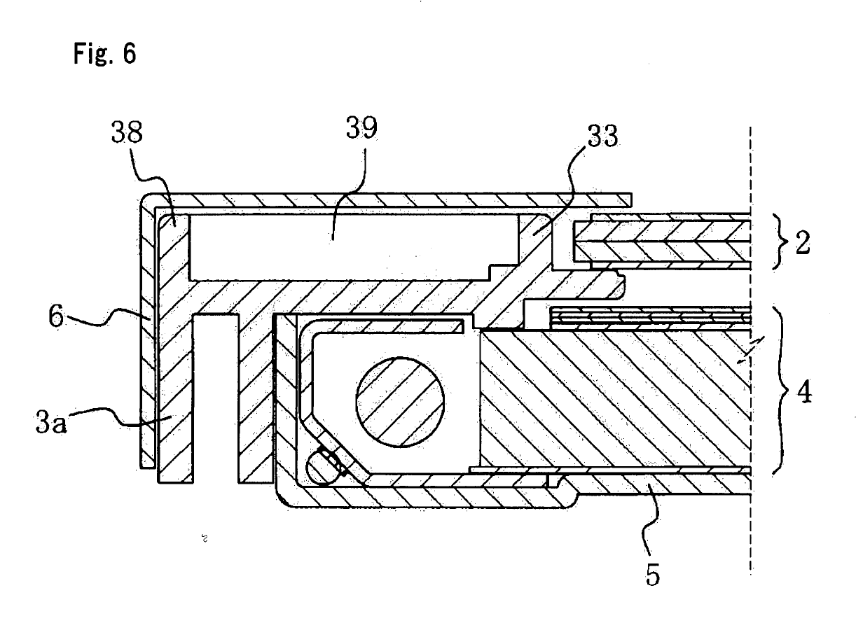

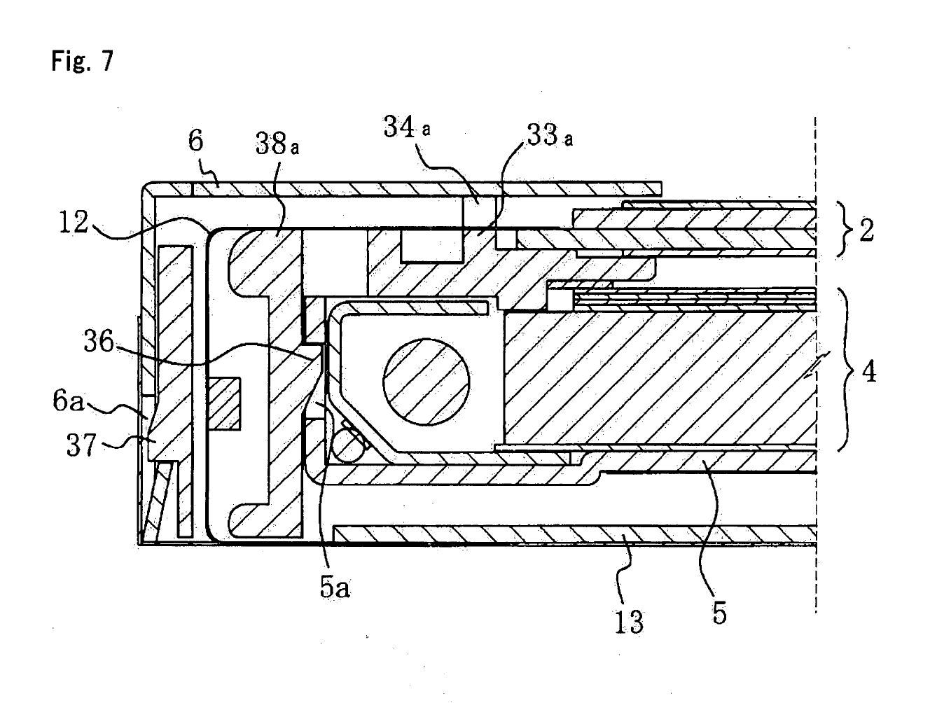

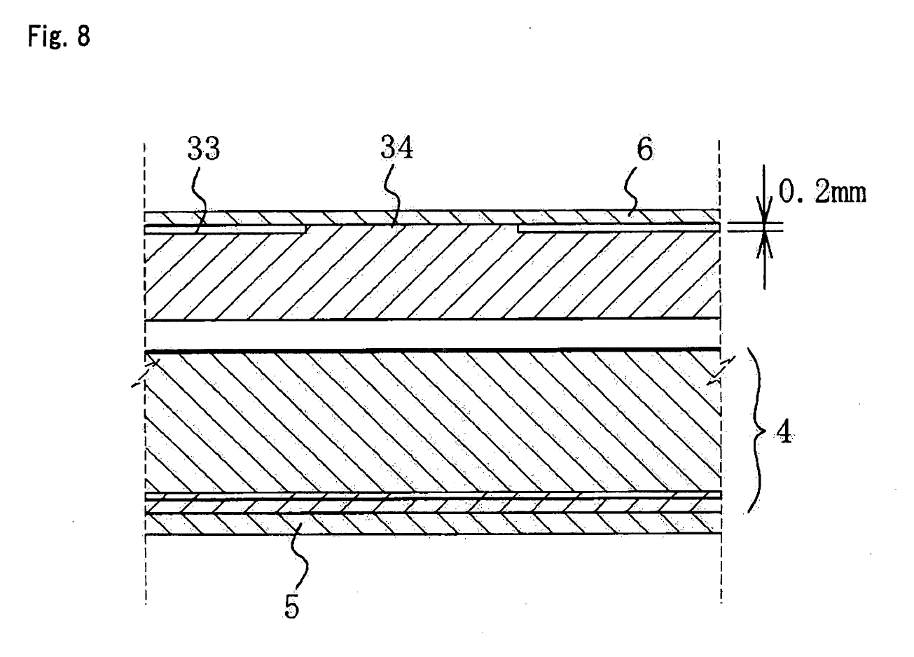

FIG. 1 is an exploded perspective view showing a liquid crystal display apparatus embodying the present invention. FIG. 2 is a perspective view showing the frame member provided in the liquid crystal display apparatus. FIG. 3 is an enlarged view showing, on an enlarged scale, principal portions of the frame member; more specifically, FIG. 3A is an enlarged view of part A shown in FIG. 2, FIG. 3B is an enlarged view of part B shown in FIG. 2, and FIG. 3C is an enlarged view of part C shown in FIG. 2. FIG. 4 is a plan view showing a liquid crystal display apparatus embodying the present invention. FIG. 5 is a sectional view along line D-D shown in FIG. 4. FIG. 6 is a sectional view along line E-E shown in FIG. 4. FIG. 7 is a sectional view along line F-F shown in FIG. 4. FIG. 8 is a sectional view along line G-G shown in FIG. 4.

As shown in FIG. 1, the liquid crystal display apparatus 1 embodying the invention is composed of a liquid crystal display panel 2, a frame member 3, a backlight unit 4, a back case 5, a front-face frame 6, and an insulating sheet 8.

The liquid crystal display panel 2 is a well known liquid crystal display panel produced by bonding together a pair of glass substrates with a sealing member with a liquid crystal layer formed inside, and is provided, at one side face thereof, a plurality of wiring circuit boards 12 (TCPs, i.e., tape carrier packages) having driver ICs (unillustrated), for controlling display, mounted thereon. These wiring circuit boards 12 are connected to a control circuit board 13 having a controller and the like mounted thereon.

The backlight unit 4 is composed of a plurality of sheets 9, a light guide plate 10, and light sources 7a and 7b, and is built by fitting the light sources 7a and 7b to opposite edge portions of the light guide plate 10, then fitting a reflective sheet 11 by bonding it to a bottom portion of the light guide plate 10 so as to cover the light sources 7a and 7b, and then placing a plurality of sheets (in FIG. 1, four sheets) including a diffusive sheet, a prism sheet, and the like on top of the light guide plate 10.

Next, how this liquid crystal display apparatus 1 is built will be described below. First, the backlight unit 4 is housed inside the back case 5, which is box-shaped, and these are then covered from above with the resin frame member 3, which is picture-frame-shaped. Then, first fitting hooks 36 (see FIG. 7) are made to engage with fitting holes 5a formed in the outer face of side walls of the back case 5 so that the backlight unit 4 is fixed inside the back case 5. Next, the liquid crystal display panel 2 is placed on top of the frame member 3, the wiring circuit boards 12 are laid so as to reach the back face of the back case 5, and the control circuit board 13 is fitted to the back face of the back case 5 (see FIG. 7). Then, the front-face frame 6 is fitted so as to cover the liquid crystal display panel 2, and then fitting holes 6a formed in the inner face of side walls of the front-face frame 6 are made to engage with second fitting hooks 37 (see FIG. 3C) formed on outer side faces of the frame member 3 so that the front-face frame 6 is fixed. Moreover, the insulating sheet 8 is bonded so as to cover the control circuit board 13 and the wiring circuit boards 12 to protect the wiring circuit boards 12 and the control circuit board 13.

Now, the frame member 3 of the liquid crystal display apparatus 1 built as described above will be described with reference to FIGS. 2 to 8.

As shown in FIG. 2, the frame member 3 is formed as a picture-frame-shaped resin member having a window 31 in a central portion thereof, and is composed of a pair of longer-side frame segment 3a and 3b and a pair of shorter-side frame segments 3c and 3d. Of these four sides, one shorter-side frame segment 3d has a plurality of holes 32 formed therein so as to extend in the length direction and penetrate in the height direction. These holes 32 make the shorter-side frame segment 3d mechanically less strong and easier to deform than the other three sides. Thus, when the frame member 3 is attached or detached, the shorter-side frame segment 3d deforms and thereby facilitates the work. The other three sides, in which the holes 32 are not formed, have comparatively high mechanical strength, and thus prevent unstable attachment.

Inside the frame member 3, a base 35 (see FIG. 3A) is provided for holding the liquid crystal display panel 2, which is mounted thereon. This base 35 has a predetermined thickness to hold the liquid crystal display panel 2 and simultaneously form a predetermined gap between the backlight unit 4 and the liquid crystal display panel 2. This helps prevent puddling of the liquid crystal display panel 2 resulting from its making contact with the backlight unit 4, and also prevents conduction of the heat generated in the backlight unit 4 to the liquid crystal display panel 2.

Furthermore, in a top portion of the frame member 3, a projection 33 is formed to project therefrom, in a position close to the outer edge of the liquid crystal display panel 2 mounted thereon. This projection 33 is formed in a substantially rectangular shape as seen in a plan view so as to extend along the outer edge of the liquid crystal display panel 2, and, in four comer portions 30a to 30d of the frame member 3, ribs 34 having a predetermined height are formed in a tip portion of the projection 33 as shown in FIG. 3A. Such ribs 34 are formed not only in the comer portions 30a to 30d of the frame member 3 but also at predetermined intervals in the tip portion of the projection 33 on the longer-side frame segments 3a and 3b and the shorter-side frame segments 3c and 3d as shown in FIGS. 3B and 3C.

When the liquid crystal display panel 2 is mounted on the base 35, the wiring circuit boards 12 of the liquid crystal display panel 2 are located on, of all the sides of the frame member 3, one longer-side frame segment 3b. Accordingly, the projection 33a on this longer-side frame segment 3b is formed slightly lower than the projection 33 along the other sides to facilitate the laying of the wiring circuit boards 12. Even then, the ribs 34a on the longer-side frame segment 3b reach the same height as those along the other three sides to support the front-face frame 6 horizontally.

The projection 33 and 33a, in particular the part thereof on the longer-side frame segments 3a and 3b, is liable to go out of shape or otherwise deform. For this reason, outside the projection 33 and 33a, an auxiliary projection 38 and 38a having approximately the same shape as the projection 33 and 33a is formed, and the projection 33 and 33a and the auxiliary projection 38 and 38a are joined together with joining portions 39 and 39a and are thereby reinforced (see FIG. 3).

FIG. 4 is a front view showing a liquid crystal display apparatus embodying the present invention in its assembled state. Now, with reference to FIGS. 5 to 8, which are sectional views cut along different cutting lines shown in FIG. 4, the structure of relevant portions of the liquid crystal display apparatus will be described in detail.

FIG. 5 is a sectional view along line D-D shown in FIG. 4, and FIG. 6 is a sectional view along line E-E shown in FIG. 4. Of these two diagrams, FIG. 5 is a sectional view cut along a cutting line that passes through ribs 34, and FIG. 6 is a sectional view cut along a cutting line that does not pass through ribs 34. These diagrams show that, after completion of assembly, the front-face frame 6 is supported on the ribs 34 formed in a tip portion of the projection 33 so as not to make contact with the liquid crystal display panel 2.

As a result of the front-face frame 6 being supported on a supporting member having bumps and dips formed by the projection 33 and the ribs 34 as described above, the mechanical strength of the supporting member is increased. In addition, as a result of the ribs 34 (34a) being formed not only in the comer portions 30a to 30d of the frame member 3 but also along the sides thereof, such as on the longer-side frame segment 3a, as shown in FIGS. 5 and 8, even when the front-face frame 6 warps, no degraded display results. The ribs 34 on the longer-side frame segment 3a has a height as small as, for example as shown in FIG. 8, about 0.2 mm, and giving them such a height helps obtain high mechanical strength.

To summarize, the liquid crystal display apparatus 1 described above has the following features. First, there are provided: a liquid crystal display panel 2; a frame member 3 on which the liquid crystal display panel 2 is mounted and that is formed substantially in the shape of a picture frame; and a front-face frame 6 that is formed in the shape of a box having an open portion 6b (see FIG. 1), that covers a peripheral portion of the liquid crystal display panel 2 and the frame member 3, and that, at the side faces thereof, engages with the frame member 3. The frame member 3 has a picture-frame-shaped projection 33 and 33a formed to project therefrom so as to surround the outer edge of the liquid crystal display panel 2, and, in a tip portion of the projection 33 and 33a, ribs 34 and 34a having a predetermined height are formed at a predetermined interval in the length direction of the picture frame. The ribs 34 and 34a support the front-face frame 6.

Second, there is provided a back case 5 on which a backlight unit 4 located below the liquid crystal display panel 2 is mounted. The back case 5, at the side faces thereof, engages with the frame member 3. The frame member 3 is formed by joining together a pair of shorter-side frame segments 3c and 3d and a pair of longer-side frame segments 3a and 3b. One of the pair of shorter-side frame segments 3c and 3d has a plurality of holes 32 formed therein so as to extend in the length direction and penetrate in the height direction.

FIG. 7 is a sectional view along line F-F shown in FIG. 4. As shown in FIG. 7, the projection 33a on the longer-side frame segment 3b facing the wiring circuit boards 12 connected to the liquid crystal display panel 2 is formed low, and its height is approximately equal to the height at which the wiring circuit boards of the liquid crystal display panel 2 mounted on the base 35 are led out. At this height, the wiring circuit boards 12 do not need to be bent when laid on the frame member 3. Thus, assembly can be performed without applying unnecessary stresses to the wiring circuit boards 12. Moreover, the ribs 34a on the longer-side frame segment 3b are located between the plurality of (in FIG. 4, four) wiring circuit boards 12 led out of the liquid crystal display panel 2 so as not to interfere with the laying of the wiring circuit boards 12.

As described above, in a liquid crystal display apparatus embodying the present invention, ribs 34 (34a) that support a front-face frame 6 of a resin frame member 3 are formed on a projection 33 (33a) having a predetermined height. Thus, a front-face frame 6 supporting member, formed by the ribs 34 (34a) and the projection 33 (33a), has such bumps and dips as to offer high mechanical strength and resist deformation and warping. Thus, it is possible to prevent the resin from going out of shape and thereby prevent the clearance between the front-face frame 6 and the liquid crystal display panel 2 from becoming uneven.

What is claimed is:

1. A liquid crystal display apparatus comprising:
a liquid crystal display panel;
a resin frame member on which the liquid crystal display panel is mounted and that is formed in a shape of a picture frame; and
a front-face frame that is formed in a shape of a box having an open portion, that covers an edge portion of the liquid crystal display panel and the frame member, and that, at side faces thereof, engages with the frame member,
wherein the frame member has formed thereon:
a projection in a shape of a picture frame, the projection being formed so as to surround an outer edge portion of the liquid crystal display panel; and
ribs having a predetermined height, the ribs being formed in a tip portion of the projection and arranged at a predetermined interval in a length direction of the picture frame so as to support the front-face frame.

2. The liquid crystal display apparatus of claim 1,
wherein the ribs are formed at least in four corners of the projection in the shape of the picture frame.

3. The liquid crystal display apparatus of claim 1,
wherein there is provided a back case on which a backlight unit located below the liquid crystal display panel is mounted, the back case, at side faces thereof, engaging with the frame member, the frame member being formed by joining together a pair of shorter-side frame segments and a pair of longer-side frame segments, one of the pair of shorter-side frame segments having a plurality of holes formed therein so as to extend in a length direction and penetrate in a height direction.

4. The liquid crystal display apparatus of claim 1,
wherein the projection in the shape of the picture frame is so formed as to be lower in a portion thereof where a wiring circuit board of the liquid crystal display panel mounted thereon is located than elsewhere.
